(19) United States
(12) Patent Application Publication
(10) Pub. No.: US 2015/0048189 A1
(43) Pub. Date: Feb. 19, 2015

(54) JAW CRUSHER

(71) Applicant: SANDVIK INTELLECTUAL PROPERTY AB, Sandviken (SE)

(72) Inventors: Martin Lindberg, Malmo (SE); Karin Ljunggren, Ystad (SE); Roger Sjobeck, Malmo (SE)

(21) Appl. No.: 14/388,365

(22) PCT Filed: Mar. 15, 2013
(86) PCT No.: PCT/EP2013/055314

§ 371 Date: Sep. 26, 2014

(30) Foreign Application Priority Data
Mar. 29, 2012 (EP) 12162137.9

(51) Int. Cl. B02C 1/04; B02C 23/04

(52) U.S. Cl. CPC B02C 1/04; B02C 23/04
USPC 241/198.1; 241/285.2

(57) ABSTRACT

A jaw crusher has a substantially fixed jaw and an opposed movable jaw. A pair of opposed side walls extend from either side of the jaws to define a crushing zone. Each side wall includes one or a plurality of side liners configured to protect the side walls. A security or capture projection extends from the side wall to one side and adjacent to each side liner and prevents the side liner from falling downward from the crushing zone in the event of dislodgement from its mounting position during use.

### FIELD OF INVENTION

The present invention relates to a jaw crusher and in particular, although not exclusively, to a jaw crusher having protective side liners and at least one security projection to prevent the side liners falling from their mounting position.

### BACKGROUND ART

Jaw crusher units typically comprise a fixed jaw and a movable jaw that define a crushing zone therebetween and a drive mechanism operative to rock the movable jaw back and forth in order to crush material in the crushing zone.

The crushing zone defined between the fixed jaw and the movable jaw is generally convergent towards its lower discharge end so that crushable material fed to the upper and wider end of the zone is then capable of falling downward under gravity while being subject to repeated cycles of crushing movement in response to the cyclical motion of the movable jaw. The crushed material is then discharged under gravity through the narrower lower discharge end onto a conveyor belt for onward processing or final discharge from the crusher unit to a suitable stock pile.

To protect the main operative components of the crusher, replaceable wear plates are typically fitted to the impact or crushing faces of the fixed and movable jaws.

Additionally, the side walls which extend between and either side of the fixed and movable jaws and further define the crushing zone, are generally fitted with side liners. The wear plates and side liners a typically made from a hardened material which has maximum abrasion resistance and are designed to be replaceable.

Example jaw crushers fitted with removable wear plates and side liners are disclosed in U.S. Pat. No. 3,140,057; U.S. Pat. No. 3,984,058 and US 2009/0152387.

However, during use it is not uncommon for the protective side liners to be dislodged from their mounting position due to the continued impact with the crushed material. Once dislodged, the side liners fall downwardly into the crusher unit and damage underlying components. Inconvenient repair is then required. There is therefore a need for a jaw crusher unit that addresses these disadvantages.

### SUMMARY OF THE INVENTION

Accordingly, one objective of the present invention is to provide apparatus to inhibit and in particular prevent side liners, mounted on the side walls adjacent to the fixed and movable jaws, from falling downwardly in the event that they are dislodged from their mounting position during use. In particular, the objective is achieved by a stop or security projection extending from the side wall at the region of the crushing zone, to one side of a respective side liner. In the event that the side liner does become dislodged, its downward movement is arrested by contact with the capture projection such that apparatus and components below the crushing zone are protected from impact damage.

According to a first aspect of the present invention that is provided a jaw crusher comprising: a substantially fixed jaw and an apposed movable jaw, each jaw having a respective crushing face; a pair of opposed side walls extending between the fixed and movable jaws either side of each crushing face; a crushing zone defined by the fixed and movable jaws and the opposed side walls, the crushing zone having an upper region and a lower region; at least one side liner removably mounted at each of the side walls, the side liner having a length extending in a direction between the upper and lower regions of the crushing zone and a corresponding width defined by two lengthwise converging width edges wherein the width of the side liner decreases along its length; the jaw crusher characterised by: at least one capture projection extending from at least one of the side walls and positioned to one side of a respective side liner adjacent to one of the width edges, the capture projection configured to stop the side liner falling in a downward direction from the crushing zone in the event of the side liner becoming dislodged from the side wall.

Preferably, at least one of the width edges is continuously substantially straight or curved between an upper corner and a lower corner of the side liner.

More preferably, the capture projection is elongate and comprises a length and a width wherein at least a region along the length is substantially aligned with the length of the side liner. More preferably still, the capture projection is curved, bent or angled along its length. Preferably, at least a portion of the capture projection is curved, bent or angled in a direction away from the width edge of the side liner.

Optionally, the capture projection is in non-contact with the width edge of the side liner to provide a spatial gap between the capture projection and the width edge. Alternatively, at least a portion of the capture projection is in touching contact with the width edge of the side liner.

Preferably, the capture projection is welded at the side wall or is mounted at the side wall via anchorage screws, bolts or pins. Optionally, the capture projection is removably mounted at the side walls.

Optionally, the side liner comprises substantially straight width edges extending the full length of the side liner between respective upper and lower corners, the capture projection positioned to one side of one of the straight width edges. Optionally, a thickness by which the capture projection extends from the side wall is less than, equal to or greater than a thickness by which the side liner extends from the side wall.

Preferably, the capture projection is positioned substantially to one side of the movable jaw relative to the fixed jaw. Optionally, the capture projection is adjustably mounted at the side wall. Optionally, the capture projection comprises a trapezium or triangular geometry.

Preferably, the width edge adjacent the capture projection is substantially devoid of notches, recesses or indents along its length. Preferably, the jaw crusher comprises a plurality of capture projections, each one of the plurality of capture projections positioned to one side of a width edge of a respective side liner.

According to a further aspect of the present invention that is provided protective apparatus for a jaw crusher having side liners, the apparatus comprising: a side liner capture device comprising a body projectable into a crushing zone of the jaw crusher from at least one side wall of the crushing zone, the side wall extending to one side and between a fixed jaw and a movable jaw; wherein the body is mountable at one side of a removable side liner mounted on the side wall adjacent one of a pair of width edges of the side liner at a region of the side liner where the width edges converge in a lengthwise direction of the side liner such that at least a portion of the body is positionable directly below at least a portion of the side liner adjacent the width edge; wherein the portion of the body is configured to abut the portion of the width edge and prevent the side liner falling in a downward direction from the crushing zone in the event of the side liner becoming dislodged from its mounted position at the side wall.

### BRIEF DESCRIPTION OF DRAWINGS

A specific implementation of the present invention will now be described by way example only and with reference to the following drawings:

FIG. 1 is a perspective view of a jaw crusher unit according to a specific implementation of the present invention;

FIG. 2 is further perspective view of the jaw crusher unit of FIG. 1 with selected components to one side of the crushing zone removed for image clarity;

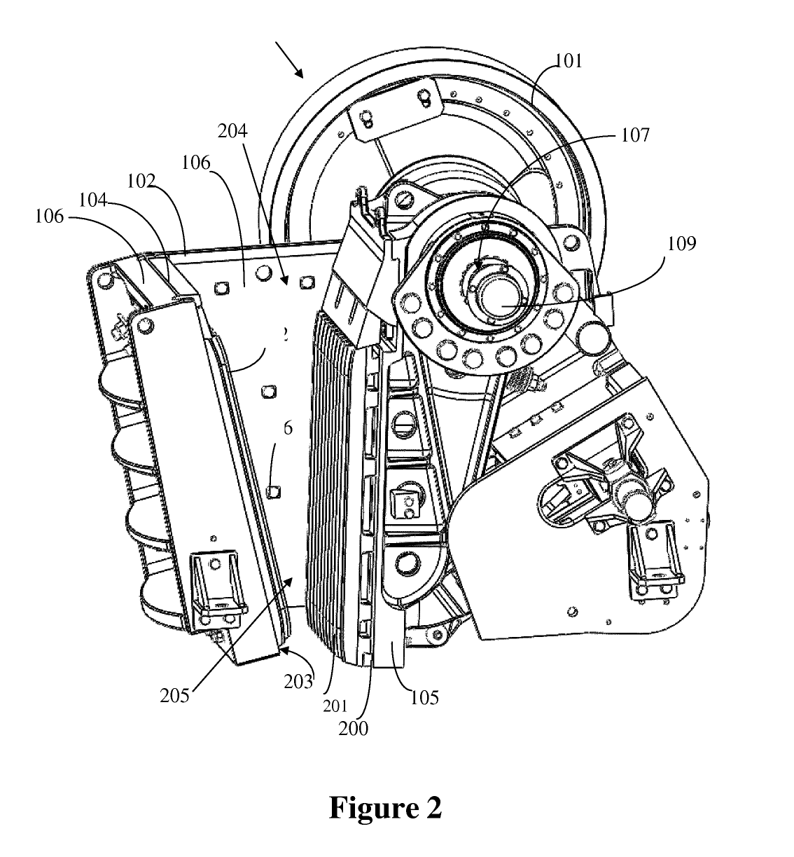

FIG. 3 is a further perspective view of the jaw crusher unit of FIG. 2 showing selected components in which the side walls that, in part, define the crushing zone are protected with side liners which are, in turn, prevented from falling downward from the crushing zone by a capture projection extending from the side wall to one side of the side liner according to a specific implementation of the present invention;

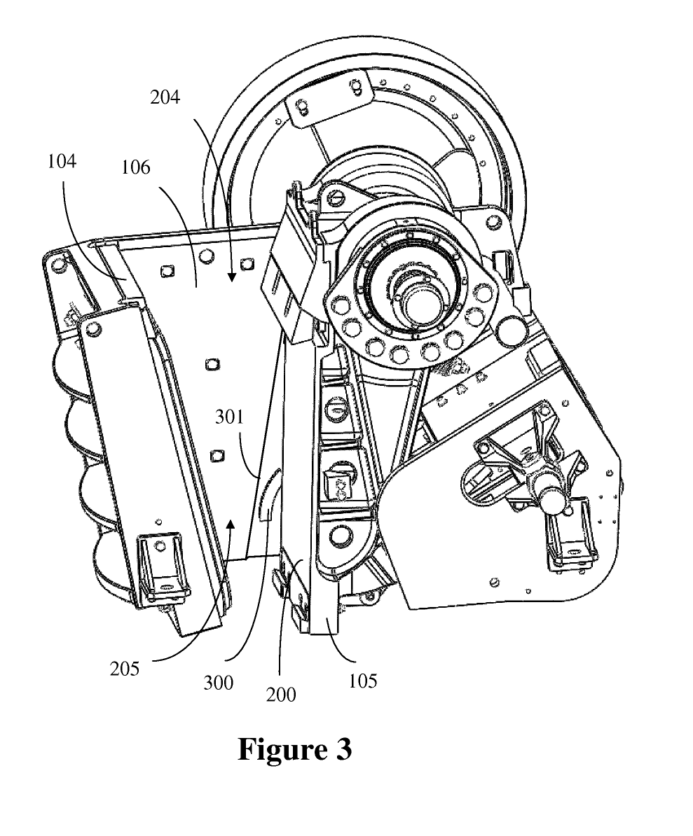

FIG. 4 is a further magnified perspective view of the capture projection and jaw crusher of FIG. 3.

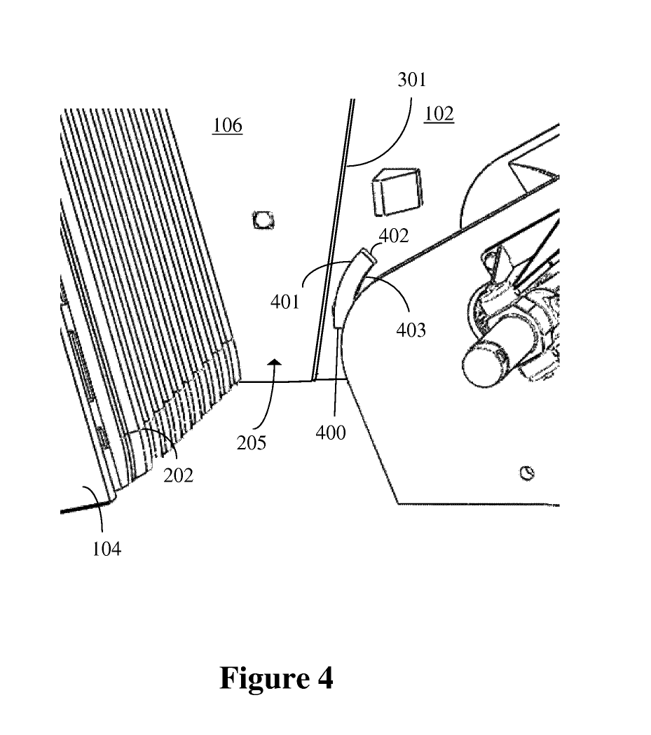

FIG. 5 is further perspective view of components of the jaw crusher of FIG. 4 in which the side liner has become dislodged from its mounting position at one of the side walls and is maintained in position at the crushing zone by contact with the capture projection.

### DETAILED DESCRIPTION OF PREFERRED EMBODIMENTS OF THE INVENTION

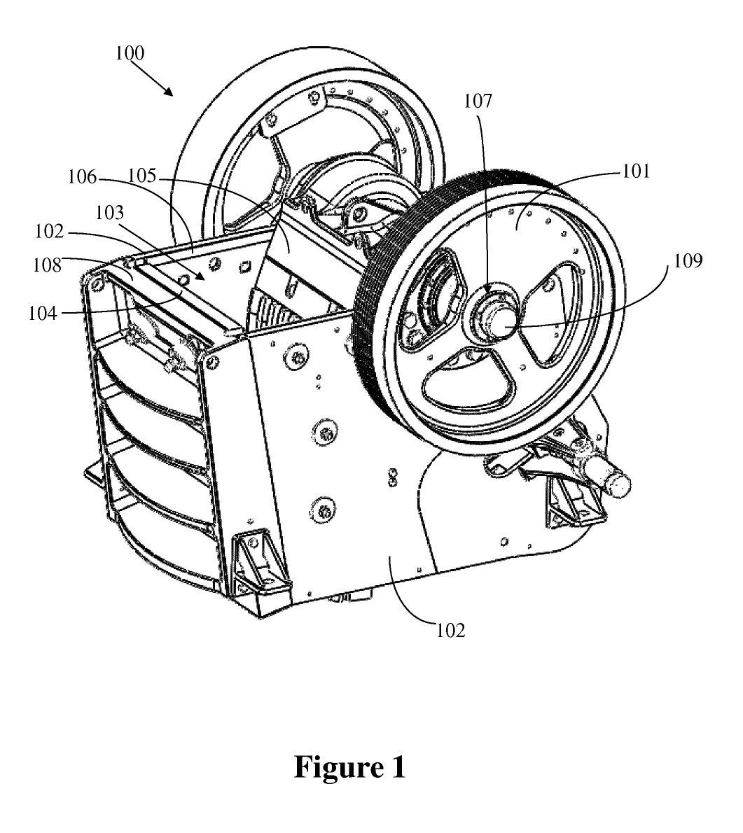

FIG. 1 is a perspective view of a jaw crusher unit 100 having a frame 108 upon which is mounted a substantially planar fixed jaw 104. A substantially planar movable jaw 105 is mounted eccentrically at a rotatable shaft 107 (extending from underneath an end cap 109) and is positioned separated and opposed to fixed jaw 104. The orientation of fixed jaw 104 and movable jaw 105 relative to one another is convergent along their respective lengths such that a separation distance between a crushing face 203 of fixed jaw 104 and a corresponding crushing face 203 of movable jaw 105 decreases in the downward lengthwise direction. A suitable wear plate 202 is removably attached to crushing face 203 of fixed jaw 104 and a corresponding wear plate 201 is removably attached to crushing face 203 of movable jaw 105. Two elongate side walls 102 are mounted at frame 108 and are aligned substantially perpendicular to a plane of fixed jaw 104. The side walls 102 extends either side of fixed jaw 104 and movable jaw 105 which collectively define a crushing zone 103.

The opposed fixed and movable jaws 104, 105 are oriented to be inclined relative to one another and are spaced further apart at their respective upper ends than their lower ends. Accordingly, the crushing zone 103 is convergent from an upper feed region 204 to a lower discharge region 205.

A pair of pulley wheels 101 are mounted either end of shaft 107 at an external facing side of side walls 102 being external to the crushing zone 103. Movable Jaw 105 is thereby configured for gyroscopic or eccentric motion with respect of fixed jaw 104 as pulley wheels 101 and shaft 107 are rotated via a suitable drive belt (not shown) attached to a drive motor (not shown). This movement of jaw 105 provides the necessary crushing action for material within zone 103 between the opposed wear plates 201 and 202. Material to be crushed is introduced into zone 103 via the open upper region 204 where it is crushed between jaws 104, 105 and subsequently discharged via the open lower region 205.

A plurality of removably mounted side liners 106 are attached to each side wall 102 at the region of crushing zone 103. Side liners 106 extend the full length and width of crushing zone 103 between upper and lower regions 204, 205 and each of the opposed jaws 104,105. As the crushing zone 103 is convergent lengthwise, side liners 106 comprise a generally trapezium geometry having a main length extending over the crushing zone 103 between upper region 204 and lower region 205. Each side liner 106 also comprises a width extending perpendicular to its length and the lengthwise orientation of crushing zone 103. According to the trapezium geometry, the width of each side liner 106 decreases lengthwise from the upper 204 to lower 205 regions.

According the preferred embodiment, each side liner 106 comprises two non-parallel width edges 200 that define the width of side liner 106 along its length. Each side liner 106 is arranged such that edges 301 converge in a downward direction from upper region 204 to lower region 205. In particular, the angled alignment of edges 301 is approximately parallel to the angled alignment of fixed jaw 104 and movable jaw 105. Each side liner 106 is mounted at each respective side wall 102 via a plurality of anchorage bolts 206 extending through side liner 106 and anchored at side wall 102. According to the preferred embodiment, one side liner 106 is mounted at each side wall 102 and extends from the lower 205 to upper 204 regions of zone 103 so as to ensure that each side wall 102 is not exposed and is protected fully in use. According to further embodiments each liner 106 may be divided lengthwise into two sections one above the other, where the respective side edges 301 of both the upper and lower liners 106 are substantially parallel.

A capture projection 300 is attached to each side wall 102 and is positioned adjacent and to one side of a respective side liner 106. However, for clarity, only one capture projection 300 is illustrated. Each capture projection 300 is substantially elongate and comprises a first end 400 and a second end 402. According to the preferred embodiment, capture projection 300 is curved or bent along its length between ends 400, 402 such that a first length edge 403 is shorter than a second length edge 401. The capture projection 300 is orientated on side wall 102 such that the longest length edge 401 is positioned immediately opposed and closest to the width edge 301 of side liner 106 at the region of (to the side of) movable jaw 105.

Capture projection 300 is attached to side wall 102 by welding. Alternatively, the projection 300 may be attached using suitable anchorages such as bolts, screws or pins similar to those used to attach the side liners 106 to side walls 102.

Each projection 300 is positioned adjacent to the respective liner 106 so as to create a narrow spatial gap between opposed edges 401 and 301. This gap may typically be in the range of 0 to 50 mm at the closest point such that the projection 300 will always contact the liner 106 in the event of it becoming dislodged. Each projection 300 is curved along its length and aligned on each side wall 102 such that at least a portion (a lower region) of its length is aligned substantially parallel with the movable jaw 105 starting from end 400. The remaining (upper length) portion of projection 300 is then angled, curved or bent away from width edge 301 so as to increase the separation gap between opposed edges 301, 401 in a direction from lower region 205 to upper region 204 of crushing zone 103. According to the preferred embodiment, the thickness of each projection 300 is slightly less than a thickness of each side liner 106 so as to not interfere with the motion of movable jaw 105 during operation of the crusher.

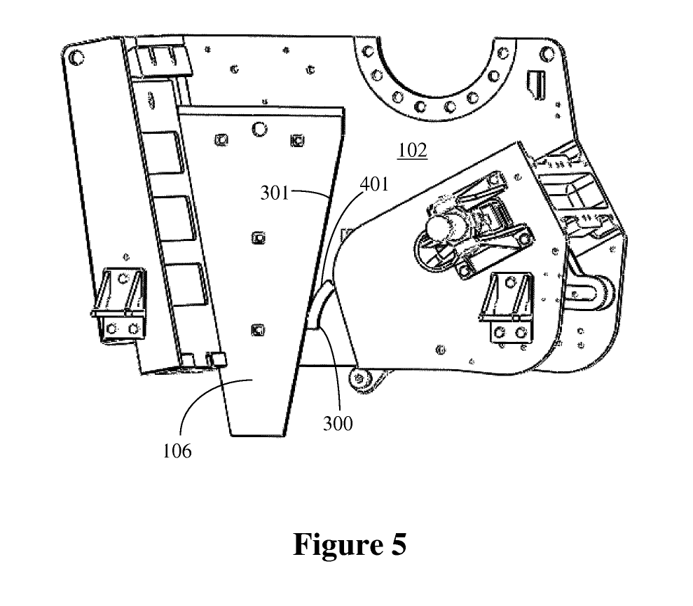

FIG. 5 illustrates the unwanted dislodgement of liner 106 from side wall 102, due to a failure of mountings 206. In this event, projection 300 acts to stop the liner 106 from falling from the region of zone 103 by abutment between opposed edges 301, 401. This abutment occurs as a region of liner 106 is positioned above a region of projection 300 in a vertical plane, parallel to the plane of each side wall 102. In particular liner 106 is orientated to extend over projection 106 in the vertical plane due to the width of liner 106 being greater at its upper end than its lower end. Additionally, a width of each projection 300 along its length is sufficient to provide the required integrity to withstand the impact and weight of liner 106 in the event of capture following its dislodgement from side wall 102. Approximately, a length-to-width ratio of projection 300 is in the range 3 to 4:1.

According to the preferred embodiment, each projection 300 is positioned to one side of a respective liner 106 below its mid-length region, that is, adjacent a lower half of liner 106 closest to the discharge end 205 of zone 103. However, according to further embodiments, each projection 300 may be positioned above or at this mid length region.

According to further embodiments, each projection 300 may be positioned at the respective side walls 102 so as to be in touching contact with a respective side liner 106 during normal operation of the crusher 100. In particular, a portion of the longest length edge 401 of projection 300 may contact a region along the respective width edge 301 of liner 106.

According to further embodiments, a plurality of capture projections 300 may be positioned adjacent any single respective side liner 106 for example at an upper and a lower position along the length of liner 106. Additionally, and according to further embodiments, each capture projection 300 may be movably mounted at each respective side wall 102 so that its position relative to side liner 106 and in particular width edge 301 may be adjusted. According to further embodiments, each capture projection 300 is removably mounted at each respective side wall 102.

1. A jaw crusher comprising:
a substantially fixed jaw and an opposed movable jaw;
a pair of opposed side walls extending from either side and between the fixed and movable jaws;
a crushing zone defined by the fixed and movable jaws and the opposed side walls, the crushing zone having an upper region and a lower region;
at least one side liner removably mounted at each of the side walls, the side liner having a length extending in a direction between the upper and lower regions of the crushing zone and a corresponding width defined by two lengthwise converging width edges, wherein the width of the side liner decreases along its length; and
at least one capture projection extending from at least one of the side walls and positioned to one side of a respective side liner adjacent to one of the width edges, wherein the capture projection is configured to abut the width edge and prevent the side liner falling in a downward direction from the crushing zone in the event of the side liner becoming dislodged from a side wall.

2. The jaw crusher as claimed in claim 1, wherein at least one of the width edges is continuously substantially straight between an upper corner and a lower corner of the side liner.

3. The jaw crusher as claimed in claim 1, wherein the capture projection is elongate and has a length and a width, at least a region along the length being substantially aligned with the length of the side liner.

4. The jaw crusher as claimed in claim 3, wherein the capture projection is curved along its length.

5. The jaw crusher as claimed in any claim 1, wherein the capture projection is in non-contact with the width edge of the side liner to provide a spatial gap between the capture projection and the width edge.

6. The jaw crusher as claimed in claim 1, wherein the capture projection is welded at the side wall or is mounted at the side wall via fasteners selected from the group of anchorage screws, bolts or pins.

7. The jaw crusher as claimed in claim 1, wherein the capture projection is removably mounted at the side wall.

8. The jaw crusher as claimed in claim 1, wherein the side liner has substantially straight width edges extending the full length of the side liner between respective upper and lower corners, the capture projection being positioned to one side of one of the straight width edges.

9. The jaw crusher as claimed in claim 4, wherein at least a portion of the capture projection is curved in a direction away from the width edge of the side liner.

10. The jaw crusher as claimed in claim 1, wherein the capture projection is positioned substantially to one side of the movable jaw relative to the fixed jaw.

11. The jaw crusher as claimed in claim 1, wherein the capture projection is adjustably mounted at the side wall.

12. The jaw crusher as claimed in claim 1, wherein the side liner has a trapezium geometry.

13. The jaw crusher as claimed in claim 1, further comprising a plurality of capture projections, each one of the plurality of capture projections being positioned to one side of a width edge of a respective side liner.

14. A protective capture device comprising:
a jaw crusher having a substantially fixed jaw and an apposed opposed movable jaw;
a pair of opposed side walls extending from either side and between the fixed and movable jaws;
a crushing zone defined by the fixed and movable jaws and the opposed side walls, the crushing zone having an upper region and a lower region;
at least one side liner removably mounted at each of the side walls, the side liner having a length extending in a direction between the upper and lower regions of the crushing zone and a corresponding width defined by two lengthwise converging width edges, wherein the width of the side liner decreases along its length; and
at least one capture projection extending from at least one of the side walls and positioned to one side of a respective side liner adjacent to one of the width edges, wherein the capture projection abuts the width edge and prevents the side liner from falling in a downward direction from the crushing zone in the event of the side liner becoming dislodged from the a side wall.

15. A protective apparatus for a jaw crusher having side liners, the apparatus comprising a side liner capture device including a body that projects into a crushing zone of the jaw crusher from at least one side wall of the crushing zone, the side wall extending to one side and between a fixed jaw and a movable jaw, wherein the body is mountable at one side of a removable side liner mounted on the side wall adjacent one of a pair of width edges of the side liner at a region of the side liner where the width edges converge in a lengthwise direction of the side liner such that at least a portion of the body is positioned directly below at least a portion of the side liner adjacent the width edge, and wherein the portion of the body is configured to abut the portion of the width edge and prevent the side liner falling in a downward direction from the crushing zone in the event of the side liner becomes dislodged from its mounted position at the side wall.

16. The jaw crusher as claimed in claim 1, wherein at least one of the width edges is continuously substantially curved between an upper corner and a lower corner of the side liner.

17. The jaw crusher as claimed in claim 3, wherein the capture projection is bent along its length.

18. The jaw crusher as claimed in claim 3, wherein the capture projection is angled along its length.

19. The jaw crusher as claimed in claim 4, wherein at least a portion of the capture projection is bent in a direction away from the width edge of the side liner.

20. The jaw crusher as claimed in claim 4, wherein at least a portion of the capture projection is angled in a direction away from the width edge of the side liner.

21. The jaw crusher as claimed in claim 1, wherein the side liner has a triangular geometry.
